(19) United States
(12) Patent Application Publication
(10) Pub. No.: US 2026/0076293 A1
(43) Pub. Date: Mar. 19, 2026

(54) A MACERATOR

(71) Applicant: MASTEK LIMITED, Cootehill, Co. Cavan (IE)

(72) Inventor: Paul QUINN, Cootehill (IE)

(21) Appl. No.: 19/109,842

(22) PCT Filed: Sep. 7, 2023
(86) PCT No.: PCT/EP2023/074639

§ 371 Date: Mar. 7, 2025

(30) Foreign Application Priority Data
Sep. 8, 2022 (GB) 2213145.2

(51) Int. Cl. A01C 23/00

(52) U.S. Cl. CPC A01C 23/002

(57) ABSTRACT

A slurry macerator (10) comprising a housing (20) having first and second sidewalls (90,100) and at least one removable outlet sideplate (140,150) at the sidewalls (90,100) for covering a housing outlet (120,130), a slurry chamber (30) in the housing (20) for receiving slurry from a slurry inlet on the housing (20), and at least one knife plate (180) and at least one cutting blade (340) co-operable with the knife plate (180) for macerating slurry in which the knife plate (180) is received in a knife plate mounting (240) defined on the housing (20).

### INTRODUCTION

This invention relates to a macerator and more particularly to an animal, human or vegetative material slurry macerator and to a slurry applicator comprising the slurry macerator.

### BACKGROUND OF THE INVENTION

Slurry spreading is widely used in agriculture as a fertilisation method. Two main applicator types are used to spread slurry. In a commonly used first method, slurry is spread from a tanker being drawn by a tractor. The slurry is discharged from the rear of the tanker under pressure and distributed through the air by a splash plate. Use of a splash plate to distribute the slurry is inexpensive but suffers from a number of disadvantages. For example, much of the environmentally unfriendly ammonia (NH₃) in the slurry is emitted to the air, undesirable strong odours are emitted and up to about a third of the valuable nitrogen component of slurry can be lost.

In order to overcome the problems associated with the splash plate distribution method, dribble bar/band spreaders (hereinafter referred to as band spreaders) were developed in which the slurry is pumped under pressure from a tanker via a pipeline to a series of outlets spaced apart on a boom so that the slurry is placed directly on the ground without splashing resulting in reduced odour, NH₃ emissions and nutrient loss. Band spreaders can also employ trailing shoes where a crop parting shoe is located at each outlet of the band spreader to assist in targeting the slurry at the base of crops. Shallow injectors or deep injectors can also be employed where the macerated slurry is injected into soil.

In order to ensure uninterrupted flow of slurry through slurry applicators, the slurry applicator is generally provided with a macerator having a motor, powered by the hydraulic system of the tractor, to chop or macerate solids (vegetation, fibres, hair and the like and debris such as timber, plastics and other waste materials) present in the slurry. The solids and debris are typically macerated in the macerator by a cutting plunger having at least one rotatable cutting blade which is spring-biased against a stationary knife plate which is secured to threaded holes in an outlet sideplate of the macerator housing by stainless-steel countersunk bolts. However, the countersunk bolts can be difficult to access and remove due to a build-up of solid matter over the bolt head and corrosion of the threaded holes resulting in increased machine downtime during maintenance operations such as knife plate replacement. In order to address this problem, it is known to weld a threaded bar to the back of the knife plate to secure the knife plate to the outlet sideplate. However, this configuration also suffers from a number of disadvantages. Firstly, the threaded bar typically has a much lower carbon content than the knife plate itself which can lead to an inherently weaker contact/connection. Secondly, the threaded bar has to be manufactured from some form of carbon steel which can be susceptible to corrosion. Finally, replacement or re-attachment of the threaded bar cannot be achieved using common convectional welding methods as fusion welding is required.

An object of the invention is to overcome at least some of the problems of the prior art.

### SUMMARY OF THE INVENTION

According to the invention there is provided a slurry macerator comprising
a housing having first and second sidewalls and at least one removable outlet sideplate at the sidewalls for covering a housing outlet;
a slurry chamber in the housing for receiving slurry from a slurry inlet on the housing, and
at least one knife plate and at least one cutting blade co-operable with the knife plate for macerating slurry wherein the knife plate is received in a knife plate mounting defined on the housing.

In any embodiment, the knife plate mounting is configured to support the knife plate on the housing.

In one embodiment, the knife plate mounting is formed on the sidewall of the housing.

Optionally, the knife plate mounting is machined into the sidewall.

In any embodiment, the knife plate mounting comprises a recess for receiving the knife plate at a rim of the housing outlet.

In one embodiment, the recess has a width dimension sized to receive and accommodate the diameter of the knife plate and a depth dimension sized to be less than the thickness of the knife plate so that the received knife plate stands proud of the recess.

Suitably, the recess is L-shaped in profile.

In any embodiment, the knife plate is sandwiched between the outlet sideplate and the recess.

In one embodiment, the knife plate is subjected to a compressive force by the outlet sideplate.

In any embodiment, the macerator further comprises a knife plate rotation prevention mechanism to prevent rotation of the knife plate.

In one embodiment, the knife plate rotation mechanism comprises a peripheral fixing receiving opening on the knife plate configured to receive an outlet sideplate fixing. Optionally, the peripheral fixing receiving opening comprises a notch.

In any embodiment, the knife plate rotation prevention mechanism comprises a series of peripheral notches.

In any embodiment, the macerator comprises a first outlet sideplate and a second oppositely disposed outlet sideplate.

In any embodiment, the macerator comprises a plurality of cutting blades mounted on a plunger.

In one embodiment, the cutting plunger comprises an impeller rotatably mounted in the slurry chamber.

In any embodiment, the knife plate is a stationary knife plate.

In any embodiment, the knife plate comprises slurry openings to allow egress of slurry from the slurry chamber to outlet pipe openings in the outlet sideplate.

In any embodiment, the macerator further comprises a motor mounted on an outlet sideplate.

In one embodiment, the motor is hydraulically powered.

In another embodiment, the invention relates to a slurry applicator comprising a slurry macerator as hereinbefore defined.

The invention overcomes the problems outlined above associated with the macerators of the prior art. More particularly, as the knife plate is not secured to the outlet sideplates by countersunk bolts and the like, no corrosion issues arise and no voids are present on the knife plates in which debris can accumulate and compact. Accordingly, the macerators and slurry applicators of the invention can be serviced with ease. In addition, cost savings result also result as the typically 12 mm Hardox bolt fixings required to mount the outlet sideplate/knife plate can be dispensed with and smaller bolt fixings such as 6 mm bolts used instead.

### BRIEF DESCRIPTION OF THE DRAWINGS

The invention will now be described, by way of example only, with reference to the accompanying drawings in which:

FIG. 1 is a perspective view from above and one side of a macerator of the prior art with the outlet sideplate detached from the housing to show the countersunk bolts securing the knife plate to the outlet sideplate;

FIG. 2 is an enlarged perspective view from above and one side of a countersunk bolt of the outlet sideplate FIG. 1;

FIG. 3 is a perspective view from above and one side of a macerator of the invention with an outlet sideplate and knife plate removed to reveal the side opening in the sidewall of the macerator housing covered by the outlet sideplate in which the macerator sidewall is provided with knife plate mounting defined by contouring surrounding the side opening which in the present embodiment is in the form of a circular groove-like recess for the knife plate;

FIG. 4 is an enlarged perspective view from above and one side of the groove-like recess of FIG. 3;

FIG. 5 is an enlarged perspective view from above and one side of one of the outlet sideplates and associated knife plate removed from the macerator of FIG. 3;

FIG. 6 is a cross-sectional view through the macerator of FIG. 3 with the outlet sideplate secured to the macerator housing to securely hold the knife plate in the knife plate mounting recess between the macerator housing and the outlet sideplate, and

FIG. 7 is an enlarged cross-sectional view of the knife plate of FIG. 6 being securely held in the recess of the knife plate mounting defined in the macerator sidewall by the outlet sideplate.

### DETAILED DESCRIPTION OF THE INVENTION

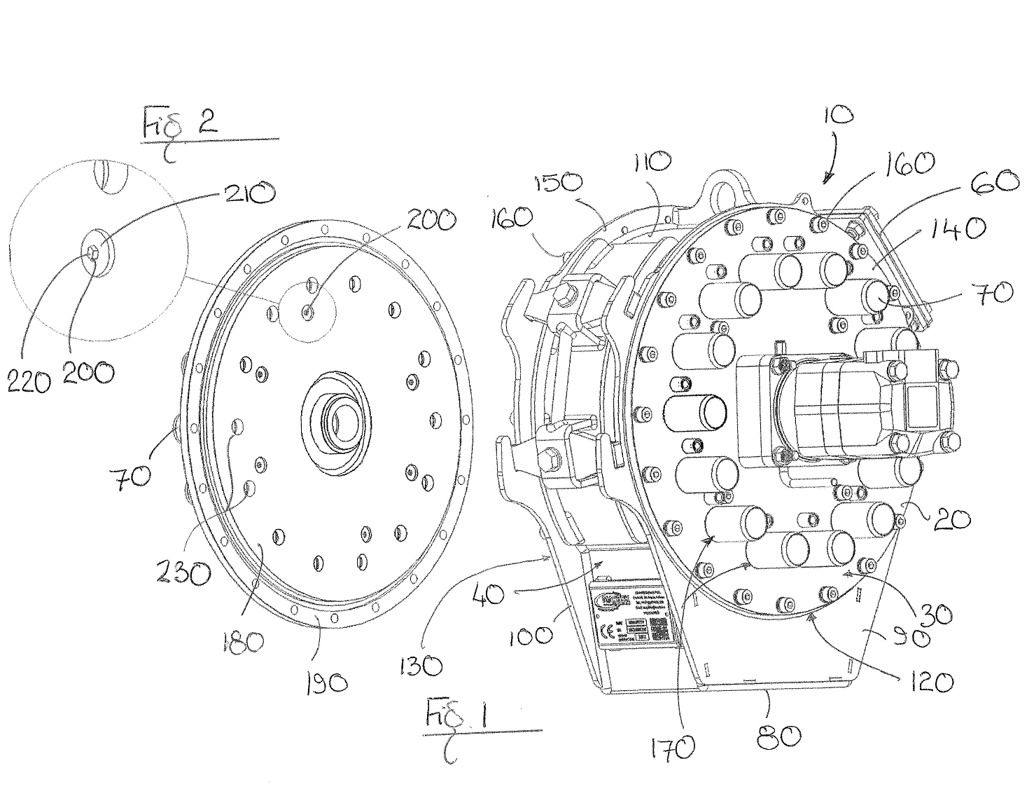

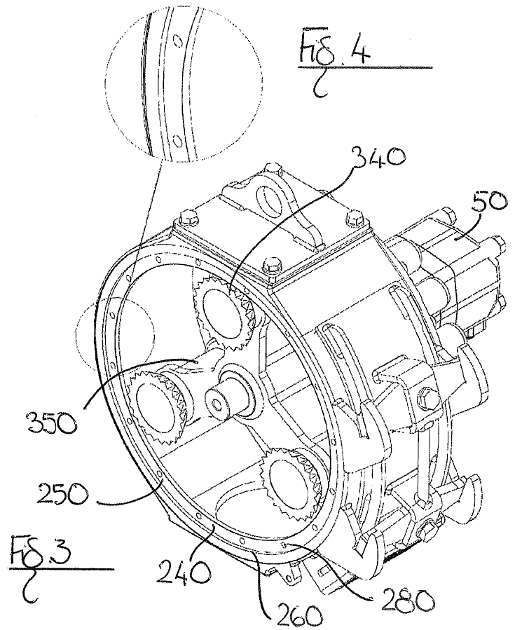

As shown in FIGS. 1 and 2 of the drawings, a slurry macerator of the prior art for macerating slurry for discharge from a slurry applicator such as a band spreader is generally indicated by the reference numeral 10 and is made up of an external housing 20 defining an internal slurry chamber 30 in which a rotatable cutting plunger 40 for cutting and chopping solids in slurry is mounted. The rotatable cutting plunger 40 is driven by a motor 50 mounted on the macerator 10 which can be hydraulically powered by a vehicle such as a tractor used to draw the band spreader. The housing 2 is provided with a slurry inlet 60 for receiving slurry under pressure from a slurry tanker on which the band spreader with macerator 10 is mounted or a slurry lagoon or the like to which the band spreader with macerator 10 can be connected by an extended slurry hose. The housing 20 is provided a plurality of macerated slurry outlet pipes 70 to which individual slurry discharge pipes/hoses (not shown) are connected to discharge the macerated slurry from the macerator 10.

The external housing 20 is made up of a housing bottom wall 80, a first drive side sidewall 90, a second oppositely disposed sidewall 100 and a central wall 110 extending between the sidewalls 90,100 to define the internal slurry chamber 30. The first sidewall 90 is provided with a first substantially circular housing outlet 120 and the second sidewall 100 is provided with an identical second substantially circular housing outlet 130 opposite the first housing outlet 120. The first housing outlet 120 is fitted with a first outlet sideplate 140 to close the first housing outlet 120 while the second housing outlet 130 is provided with a second outlet sideplate 150 to close the second housing outlet 130. The first and second outlet sideplates 140,150 are secured to the respective sidewalls 90,100 with fixings 160 such as socket head bolts which extend through the first and second outlet sideplates 140,150 in the sidewalls 90,100.

Each outlet sideplate 140,150 is provided with outlet pipe openings 170 through which slurry can pass to the outlet pipes 70. The outlet pipe openings 170 (and hence the outlet pipes 70) are evenly distributed in a circular pattern on the outlet sideplates 140,150 while the outlet pipe openings 170 and associated outlet pipes 70 are disposed directly opposite each other on the outlet sideplates 140,150. The outlet pipe openings 170 and outlet pipes 70 can be numbered as required.

As indicated above, a stationary circular and annular knife plate 180 which in use co-operates with the spring-biased cutting blade of the rotatable cutting plunger 40 to macerate the slurry is secured to the internal face 190 of each outlet sideplate 140,150 by a series of stainless-steel Allen-key operated countersunk bolts 200 to secure the knife plate 180 to threaded holes in the outlet sideplate 140,150. Each knife plate 180 is also provided with a series of knife plate slurry openings 230 corresponding in number and layout with the outlet pipe openings 170 on the outlet sideplates 140,150 though which macerated slurry can egress from the slurry chamber 30 to the outlet pipe openings 170 during rotation of the cutting plunger 40. The bolts 200 must be recessed into the knife plate 180 to ensure they are not damaged as the knife plate 180 is worn away during use thus creating a void 210 above the head 220 of the bolt 200. However, in use, the voids 210 fill up with fibre and other solid materials over time which material is constantly compacted by the spring-loaded knife cutting blades. As a result, it becomes extremely difficult to remove the compacted material to access the Allen-key mount on the countersunk bolts 200. In addition, the threaded holes in the outlet sideplates 140,150 can corrode over time making it very difficult to remove the countersunk bolts 200 when the knife plate 180 requires replacement.

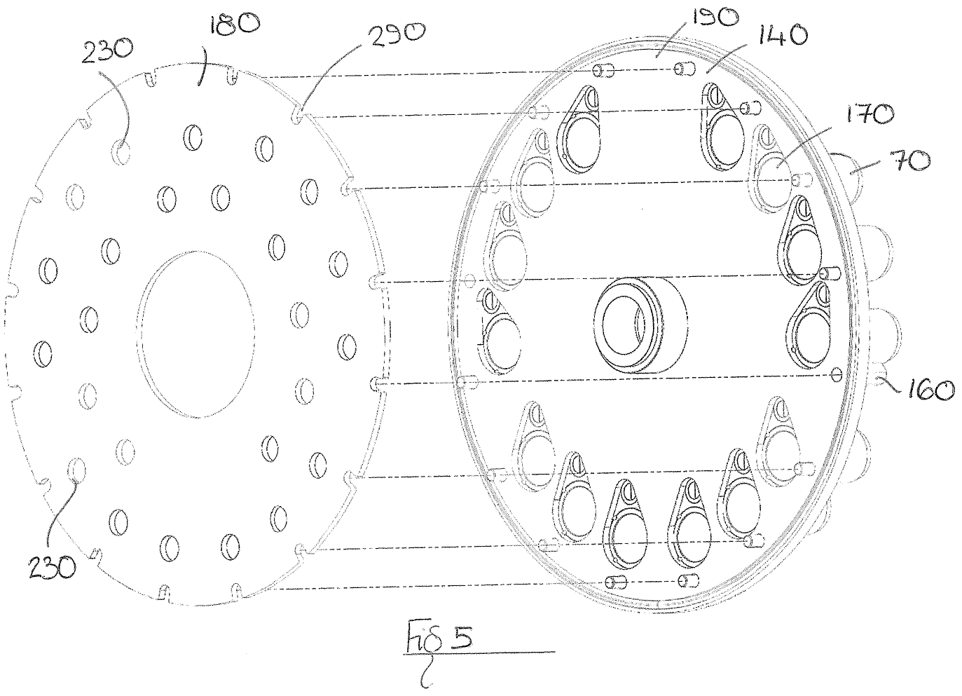

FIGS. 3 to 7 show various views of the macerator 10 of the invention which is broadly similar in construction to the macerator 10 of FIGS. 1 and 2 but in which each knife plate 180 is not mounted on the outlet sideplates 140,150 but is instead received in a knife plate mounting 240 for supporting each knife plate 140,150 provided on the sidewalls 90,100 of the macerator housing 20 so that the countersunk bolts 200 of FIGS. 1 and 2 are not required and the associated problems are eliminated. Like numerals indicate like parts.

More particularly, as shown in the drawings, the sidewalls 90,100 defining the housing outlets 120,130 are machined or tooled to define the knife plate mounting 240. The sidewalls 90,100 are provided with a circular rim 250 defining the housing outlets 120,130 which is complementary in size and shape with the outlet sideplates 140,150 and the circular rim 250 is contoured to define the knife plate mounting 240 in the form of a groove or recess 260 which is sized and shaped for receiving an outlet sideplate 140,150 to mount and support the outlet sideplates 140,150 on the housing 20. Accordingly, each knife plate 180 sits in a knife plate mounting 240 formed from a respective recess 260 at the housing outlets 120, 130 of each sidewall 90,100 of the housing 20.

As shown particularly in FIG. 7, the recess 260 is L-shaped in profile and has a width dimension which is sized to receive and accommodate the diameter of the knife plate 180 and a depth dimension which is sized to be less than the thickness of the knife plate so that the received knife plate 180 stands proud of the recess 260. The outlet sideplates 140,150 are placed over the knife plates 180 to sandwich each knife plate 180 between its associated outlet sideplate 140,150 and recess 260. As the knife plates 180 stand proud of the recess 260 a gap 270 is formed between each outlet sideplate 140,150 and its respective housing sidewall 90,100. The recess 260 is further provided with spaced apart fixing receiving holes 280 which can be threaded to receive the fixings 160.

Accordingly, upon insertion of the fixings such as bolts 160 in the first and second outlet sideplates 140,150 to secure the first and second outlet sideplates 140,150 to the sidewalls 90, 100 at the fixing receiving holes 280 of the recess 260, the knife plates 180 are gripped between the outlet sideplates 140,150 and the housing 20 to securely hold the knife plates 180 in position i.e. the outlet sideplates 140,150 exert a compressive force on the knife plates 180. A circumferential fluid-tight seal 370 is also provided between the outlet sideplates 140,150, the housing sidewall 90,100 and the knife plate 180.

As shown particularly in FIG. 5, the knife plate 180, in addition to the knife plate slurry openings 320, is provided with spaced-apart peripheral fixing receiving openings in the form of notches 290 which are configured to be contiguous with the fixing receiving openings 280 so that the fixings 160 extend through both the fixing receiving openings 280 in the of the recess 260 and the notches 290. The fixings 160 do not exert a compressive force on the knife plate 180 at the notches 290 but, in combination with the circumferential/peripheral notches 290 define a knife plate rotation prevention mechanism 300 which serves to prevent rotation of the compressed knife plate 180.

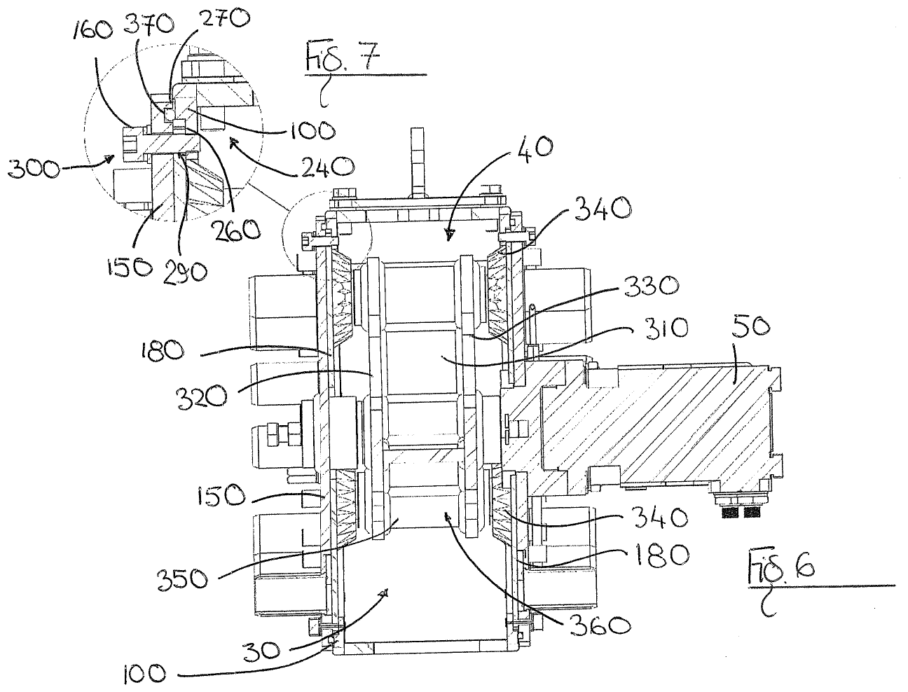

As shown in FIG. 6, the rotatable cutting plunger 40 is rotatably mounted in the slurry chamber 30 and is made up of a rotatable impeller 310 defined by a first circular impeller plate 320 and a second oppositely disposed circular impeller plate 330 spaced apart from and connected to the first impeller plate 320. In the present embodiment, each circular impeller plate 320,330 is provided with three circumferentially spaced apart spring-loaded cutting blades 340. The cutting blades 340 are mounted in three cutting blade tubes 350 extending between the impeller plates 320,330 so that each cutting blade tube 350 has a cutting blade 340 at each end thereof. Each tube 350 is provided with a powerful spring 360 to urge or bias the cutting blades 340 against the stationary knife plate 180.

Accordingly, in use, the macerator 10 is configured as shown in FIGS. 3 to 7 with each knife plate 180 mounted in the recess 260 of the knife plate mounting 240 on the macerator housing 20 and held in place by a compressive force exerted by the outlet sideplates 140,150 on the knife plates 180 with rotational movement of the knife plates 180 being prevented by the fixings 160 extending through the circumferential notches 290 on the knife plates 180. As the knife plate is not secured to the outlet sideplates by countersunk bolts and the like, no corrosion issues arise and no voids are present on the knife plates 180 in which debris can accumulate and compact. The knife plates 180 can therefore be serviced and replaced as required with ease. For example, both knife plates 180 can now be replaced in approximately 45 minutes, whereas previously, a service time of three or four hours was not uncommon to separate the knife plates 180 from the outlet sideplates 140,150 which quite often resulted in damage to threaded holes and the need to re-drill and tap out larger holes and adapt the knife plates 180 to accommodate larger countersunk bolts.

1. A slurry macerator comprising:
a housing having first and second sidewalls and at least one removable outlet sideplate at the sidewalls for covering a housing outlet;
a slurry chamber in the housing for receiving slurry from a slurry inlet on the housing; and
at least one knife plate and at least one cutting blade co-operable with the knife plate for macerating slurry,
wherein the knife plate is received in a knife plate mounting defined on the housing.

2. A slurry macerator as claimed in claim 1, wherein the knife plate mounting is configured to support the knife plate on the housing.

3. A slurry macerator as claimed in claim 1, wherein the knife plate mounting is formed on at least one of the first sidewall and the second sidewall of the housing.

4. A slurry macerator as claimed in claim 3, wherein the knife plate mounting is machined into the at least one of the first sidewall and the second sidewall.

5. A slurry macerator as claimed in claim 3, wherein the knife plate mounting comprises a recess for receiving the knife plate at a rim of the housing outlet.

6. A slurry macerator as claimed in claim 5, wherein the recess has a width dimension sized to receive and accommodate a diameter of the knife plate and a depth dimension sized to be less than a thickness of the knife plate so that the received knife plate stands proud of the recess.

7. A slurry macerator as claimed in claim 6, wherein the recess is L-shaped in profile.

8. A slurry macerator as claimed in claim 6, wherein the knife plate is sandwiched between the outlet sideplate and the recess.

9. A slurry macerator as claimed in claim 8, wherein the knife plate is subjected to a compressive force by the outlet sideplate.

10. A slurry macerator as claimed in claim 1 further comprising a knife plate rotation prevention mechanism to prevent rotation of the knife plate.

11. A slurry macerator as claimed in claim 10, wherein the knife plate rotation prevention mechanism comprises a peripheral fixing receiving opening on the knife plate configured to receive an outlet sideplate fixing.

12. A slurry macerator as claimed in claim 11, wherein the peripheral fixing receiving opening comprises a notch.

13. A slurry macerator as claimed in claim 12, wherein the knife plate rotation prevention mechanism comprises a series of peripheral notches.

14. A slurry macerator as claimed in claim 1 further comprising a first outlet sideplate and a second oppositely disposed outlet sideplate.

15. A slurry macerator as claimed in claim 1 further comprising a plurality of cutting blades mounted on a cutting plunger.

16. A slurry macerator as claimed in claim 15, wherein the cutting plunger comprises an impeller rotatably mounted in the slurry chamber.

17. A slurry macerator as claimed in claim 1, wherein the knife plate is a stationary knife plate.

18. A slurry macerator as claimed in claim 1, wherein the knife plate comprises slurry openings to allow egress of slurry from the slurry chamber to outlet pipe openings in the outlet sideplate.

19. A slurry macerator as claimed in claim 1 further comprising a motor mounted on an outlet sideplate.

20. (canceled)

21. A slurry applicator comprising:
a slurry macerator including:
a housing having first and second sidewalls and at least one removable outlet sideplate at the sidewalls for covering a housing outlet;
a slurry chamber in the housing for receiving slurry from a slurry inlet on the housing; and
at least one knife plate and at least one cutting blade co-operable with the knife plate for macerating slurry,
wherein the knife plate is received in a knife plate mounting defined on the housing.
